(19) United States
(12) Patent Application Publication
(10) Pub. No.: US 2015/0281338 A1
(43) Pub. Date: Oct. 1, 2015

(54) SYSTEM AND METHODS THEREOF FOR ENABLING CROSS-DEVICE ACCESS RESPECTIVE OF THE USER INTENT

(71) Applicant: DOAT MEDIA LTD., Tel Aviv (IL)

(72) Inventors: Joey Joseph SIMHON, Ramat-Gan (IL); Avi CHARKAM, Givataim (IL); Rami KASTERSTEIN, Givataim (IL)

(73) Assignee: DOAT MEDIA LTD., Tel Aviv (IL)

(21) Appl. No.: 14/735,612

(22) Filed: Jun. 10, 2015

Related U.S. Application Data
(63) Continuation-in-part of application No. 14/103,536, filed on Dec. 11, 2013.
Application No. 14/103,536 is a continuation-in-part of application No. 13/712,563, filed on Dec. 12, 2012.
Application No. 13/712,563 is a continuation-in-part of application No. 13/156,999, filed on Jun. 9, 2011.
Application No. 13/712,563 is a continuation-in-part of application No. 13/296,619, filed on Nov. 15, 2011.
(60) Provisional application No. 62/010,166, filed on Jun. 10, 2014.
(60) Provisional application No. 61/822,376, filed on May 12, 2013.
(60) Provisional application No. 61/653,562, filed on May 31, 2012.
(60) Provisional application No. 61/468,095, filed on Mar. 28, 2011.
(60) Provisional application No. 61/354,022, filed on Jun. 11, 2010.

(51) Int. Cl. H04L 29/08; H04L 29/06

(52) U.S. Cl. CPC H04L 67/10; H04L 63/10; H04L 67/16

(57) ABSTRACT

A method and system for enabling cross-device access based on a user intent are provided. The method includes receiving a request to allow a second user device to access a first user device; determining an intent of a user of the first user device respective of the received request; determining, based on the user intent, at least one content resource in the first user device that can be accessed by the second user device; initializing an agent on the first user device; and causing the agent to enable the second user device to perform at least one action on the at least one content resource.

### CROSS REFERENCE TO RELATED APPLICATIONS

This application claims the benefit of U.S. Provisional Patent Application No. 62/010,166 filed on Jun. 10, 2014. This application is also a continuation-in-part application of U.S. patent application Ser. No. 14/103,536, filed on Dec. 11, 2013, now pending. The Ser. No. 14/103,536 application claims the benefit of U.S. provisional application No. 61/822,376 filed on May 12, 2013, and is a continuation-in-part of U.S. patent application Ser. No. 13/712,563 filed on Dec. 12, 2012. The Ser. No. 13/712,563 application claims the benefit of U.S. provisional patent application No. 61/653,562 filed on May 31, 2012, and is a continuation-in-part application of U.S. patent application Ser. No. 13/156,999 filed on Jun. 9, 2011, which claims the benefit of U.S. provisional patent application No. 61/468,095 filed Mar. 28, 2011 and U.S. provisional application No. 61/354,022 filed Jun. 11, 2010. The Ser. No. 13/712,563 application is also a continuation-in-part application of U.S. patent application Ser. No. 13/296,619 filed on Nov. 15, 2011. The contents of the above-referenced applications are incorporated herein by reference.

### TECHNICAL FIELD

The disclosed embodiments generally relate to methods for connecting user devices over a network, and more specifically to system and methods for enabling access to a first user device by at least one second user device over the network based on the intent.

### BACKGROUND

Most users of computing devices (herein user device or devices) are used in various settings for different tasks. These days, in order to fulfill such tasks, people are using multiple devices. For example, a user may have a smartphone and a PC, each of which can serve the user to perform the same and/or a different task. On the PC that user can edit documents while on the smartphone access content application. The PC and smartphone can both be used to access the WWW.

As different user devices are utilized for different tasks, a user switches between the devices many times during the day. In most cases, there context or data associated with a certain task is not transferred from one device to the other. This is due to the fact that in most cases the devices are decoupled. In some applications, context can be shared across devices. For example, the Google Chrome® web-browser allows to share browsing session across user devices. However, all devices need to be installed with the Chrome browser and the user must log-in to all the devices using the device user name and password. However, this solution is limited only to browsing sessions of a web browser.

A remote desktop is a solution for securely access computer devices over the Internet. That is, a remote desktop solution allows users to remotely access another computer through a dedicated software. The user devices can be made available on a short-term basis (e.g., for an ad hoc remote support), or on a long-term basis for remote access to applications and files.

Either when a short-term or a long-term access is provided a remote computer has entire access to the user device. The remote desktop solution cannot gain limited access, e.g., to a set of functions from one device to another.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for enabling cross-device access based on a user intent. The method comprises: receiving a request to allow a second user device to access a first user device; determining an intent of a user of the first user device respective of the received request; determining, based on the user intent, at least one content resource in the first user device that can be accessed by the second user device; initializing an agent on the first user device; and causing the agent to enable the second user device to perform at least one action on the at least one content resource.

Certain embodiments disclosed herein include a system for enabling cross-device access based on a user intent, comprising: a processing unit; and a memory, the memory containing instructions that, when executed by the processing unit, configure the system to: receive a request to allow a second user device to access a first user device; determine an intent of a user of the first user device respective of the received request; determine, based on the user intent, at least one content resource in the first user device that can be accessed by the second user device; initialize an agent on the first user device; and cause the agent to enable the second user device to perform at least one action on the at least one content resource.

### BRIEF DESCRIPTION OF THE DRAWINGS

The subject matter that is regarded as the disclosed embodiments is particularly pointed out and distinctly claimed in the claims at the conclusion of the specification. The foregoing and other objects, features and advantages of the disclosed embodiments will be apparent from the following detailed description taken in conjunction with the accompanying drawings.

FIG. 1 is a diagram of a network system utilized to describe the various disclosed embodiments.

FIG. 2 is a block diagram of an intent detection unit (IDU) for detecting a search intent of a user according to an embodiment.

FIG. 3 is a flowchart describing the operation of a method for detecting a search intent of a user according to an embodiment.

FIG. 4 is a flowchart describing the operation of a method for enabling access to a first user device by at least a second user device according to an embodiment.

### DETAILED DESCRIPTION

The embodiments disclosed herein are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

According to some exemplary embodiment, an access to application programs accessible through a first user device is granted to at least a second user device respective of the intent of the first user device. In an embodiment, a request from the first user device to enable the access over a network to an application program accessible through the first user device by the second user device is received. The intent of the first user device is determined respective of the request. The access to the first user device is realized by means of an agent that is configured to receive instructions from the second user device respective of the intent. The agent, when executed by the first user device, is initialized to execute actions on the application program of the first user device received over the network from the second user device.

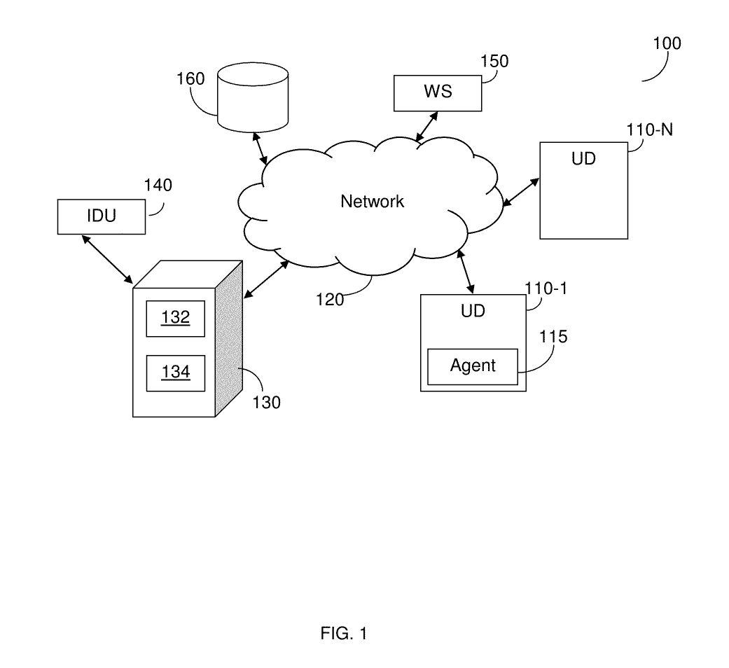

FIG. 1 depicts an exemplary and non-limiting schematic diagram of a networked system 100 utilized to describe the various disclosed embodiments. A plurality of user devices (UD) 110-1 through 110-N (collectively referred hereinafter as user devices 110 or individually as a user device 110, merely for simplicity purposes), where N is an integer equal to or greater than 1, are connected to a network 120. Each user device 110 may be a smart phone, a mobile phone, a laptop computer, a tablet computer, a wearable computing device, a personal computer (PC), a smart television and other kinds of wired and mobile appliances. The network 120 may be a local area network (LAN), a wide area network (WAN), a metro area network (MAN), the Internet, the worldwide web (WWW), a wireless network, a wired network, a cellular network, the like, and any combinations thereof.

Some of the disclosed embodiments are performed by the server 130 connected to the network 120. Specifically, the server 130 is configured to receive a request from a first user device, for example, the user device 110-1, to enable access to content resources of the first user device 110-1 by at least a second user device, for example, the user device 110-2. The content resources may include, for example, application(s) installed on the first user device, configurations and settings of the first user device, folder(s), file(s) stored in or accessible through the first user device 110-1, and so on.

The access to the content resources may be restricted by certain permission levels or access control provisions.

The server 130 is further configured to initialize an intent detection unit (IDU) 140 to determine a user intent respective of the request received from the user device 110-1. The process for determining a user intent is described in further detail herein below.

In an embodiment, the user intent represents at least a topic of interest to a user of the first user device. That is, the user intent represents the type of actions and/or contents the user wishes to enable on the second user device 110-2. The user intent is related to a specific time period. As a non-limiting example, in case the request is to enable access to the notification alerts of the first user device 110-1 by the second user device 110-2, the user intent is to enable switching between silent and normal mode of the first user device 110-1. The IDU 140 is further configured to send the determined user intent to the server 130.

Respective of the user intent, the server 130 is configured to initialize an agent 115 installed on the first user device 110-1, by which the second user device 110-2 can perform actions on the content resources of the first user device 110-1.

The agent 115 is then sent to the user device 110-1 to execute thereon. In an embodiment, the agent 115 may be part of an operating system of the user device 110. Alternatively, the agent 115 may be downloaded from an application program repository (not shown) accessible over the network 120. The agent 115 is configured to execute commands or other instructions sent from the server 130 over the network 120.

According to another embodiment, the agent 115 is sent subject to an approval from the second user device 110-2. Upon receiving at least one request from the second user device 110-2, the server 130 is configured to initialize the agent 115 to provide the second user device 110-2 an access to the first user device 110-1.

An agent 115 can be implemented as a stand-alone program or, alternatively, can communicate and be integrated with other programs or applications executed in the client device 115.

According to another embodiment, the server 130 is further configured to execute the actions received from the second user device 110-2 in the first user device 110-1 through a web source 150 without a need to install the agent 115 on the first user device 110-1. The system 100 may further include a database 160 for storing information related to the user device 110, requests received, the determined user intents, and so on.

It should be noted that the scheduling server 130 typically includes a processing unit 132 and a memory 134. The processing unit 132 may include one or more processors. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing unit 132 may be coupled to the memory 134. In an embodiment, the memory 134 contains instructions that when executed by the processing unit 132 results in the performance of the methods and processes described herein below. Specifically, the processing unit 132 may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing unit 132 to perform the various functions described herein.

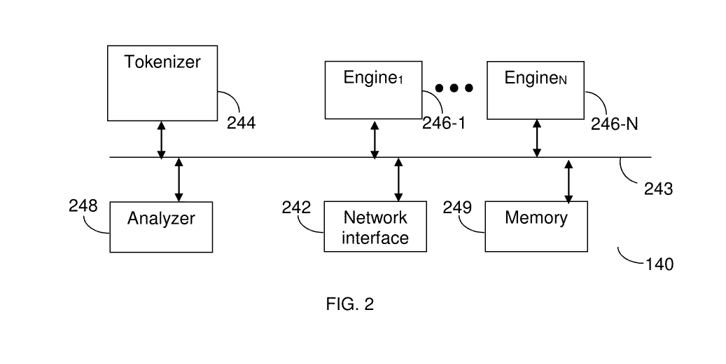

FIG. 2 depicts an exemplary and non-limiting block diagram of the IDU 140 according to an embodiment. The IDU 140 includes a network interface 242, a tokenizer 244, a plurality of engines 246-1 through 246-N, an analyzer 248, and a memory 249. The network interface 242 provides connectivity to the network 120 and is configured to receive queries from the server 230 or directly from a user device 210. The network interface 242 may further be used to communicate with the database 260 to retrieve information therefrom. The elements of the IDU 240 are communicatively coupled using a communication bus 243.

The tokenizer 244 is configured to tokenize a request to units of information (tokens). The tokenizer 244 arranges the tokens in tokenized paths to enable efficient processing by the engine 246. Each token may be, but is not limited to, a word or a series of words, or a number or a series of numbers. According to one embodiment, the tokenizer 244 may also include a filtering unit (not shown) for filtering the request. The requests can be classified into three different types of requests: definitive, fuzzy, and noisy. A definitive request is short and mapped to known entities or keywords. A fuzzy request contains a combination of known entities and keywords that are not correlated to the known entities. Noisy requests cannot be mapped to known entities, or are long and complex. According to the disclosed embodiments, an entity is an “object” in the world that can be defined with known types and attributes. Entities may be, for example, products, people, locations, companies, music bands, popular keywords, applications, zip codes, and requests components. Each entity can be associated with one or more classifications describing its essence. For example, an entity ‘Marvel®’ can be associated with the classifications gaming, media, and applications.

The filtering process is designed to simplify at least fuzzy and noisy requests. The filtering process may include removing one or more unnecessary tokens (such as preposition words) from the request. As an example, if the received request is “place files in Dropbox®”, the word “in” may be removed from the query if the token is determined to be unnecessary. A list of unnecessary tokens is defined in a semantic dictionary maintained in the database 160 or the memory 249.

The tokenized paths created by the tokenizer 144 are based on the fact that the coherent request typically includes a set of tokens (map to entities as defined above) that represents similar intents. According to one embodiment, any ambiguity between paths is resolved by using the most coherent and probable path among all possible tokenized paths. In one embodiment, a graph of connections between entities (e.g., applications connected to their profiles) is utilized to evaluate the likelihood of a certain tokenized path yielding the user's intended request result based on the connection of tokens (mapped to entities) in the same request. For example, the request “Marvel® pinball” includes two tokens: “Marvel®” and “pinball”, where the tokenized path is that the entire request deals with a pinball application, rather than a Marvel® comics application (“Marvel®” is both the brand of a comics application and gaming applications).

Each engine of the plurality of engines 146 is configured to handle different one or more topics of interest. In one embodiment, a set of engines 146 are configured to map input tokenized paths or tokens (hereinafter tokenized queries) to entities. As noted above, entities are objects that can be defined using a set of attributes such as consumer goods, locations, keywords, mobile applications (apps), person names, questions, URLs, and so on.

As a non-limiting example, an engine 246 that is configured to handle locations, search for place names (cities, states, countries) in the tokenized request, and compute the probability that the user added a location to his or her input request. As another non-limiting example, an engine 146 that handles the names of people computes the probability that a given n-gram in the tokenized request is the name of an unknown person. Such an engine uses a frequency dictionary for common names versus common words, and common last name suffixes. In the fields of computational linguistics and probability, an n-gram is a contiguous sequence of n items from a given sequence of text or speech.

As another non-limiting example, an engine 246 that handles URLs is configured to include a list of URLs, domain names, and websites, and to compute the probability that the tokenized request includes a website name. As another non-limiting example, an engine 146 computes the probability that the tokenized request includes a question word, thereby determining the probability that the entire request is a question. This is performed using pattern matching.

According to one embodiment, the probability may be computed based on at least one of: the frequency of appearance of the tokenized request within the entities by the engines, the correlation of the tokenized request to the entities, the matching between each of the tokens to the entities, the matching of the tokenized request to a plurality of request results received from an external request engine, the correlation to trend reports, and combinations thereof. As noted above, entities represent topics of interests.

The engines 246 are periodically updated with relevant content and are therefore consistent with the trends related to the respective topics. As a non-limiting example, the entities are updated by periodically downloading an index of entities from external sources (e.g., freebase.org) and names related mobile apps that can be periodically downloaded from central repositories of such applications, e.g., AppStore®.

In one embodiment, trends or popularity reports of certain keywords or requests are retrieved from external web sources 150 (FIG. 1). Such reports can be input to engines 246 and can be utilized in part to compute the probability of a certain entity. For example, a trend report shows that a keyword “JFK airport” is currently trendy, so the probability computed for a taxi application for transportation to JFK airport would be higher than the probability computed for an encyclopedia application listing the person President John F. Kennedy.

Each engine of the plurality of engines 246 then provides an output respective of the tokenized request. Such output includes the mapped entity from the engine 246 and a certainty score for the tokenized request based on the probability computed for the entity handled by a respective engine. That is, each certainty score reflects the matching of the tokenized request to the topic which the corresponding engine handles. In an exemplary embodiment, the certainty score is an integer number between 0 and 10. In one embodiment, a certainty score that does not exceed a predefined threshold is not output by the engine 246.

The outputs of the engines 246 are then analyzed by an analyzer 248 and the user intent is determined respective of the analysis. The analysis of the analyzer 248 may include: a statistical analysis, a semantic analysis, analysis of the user experience, and combinations thereof. The statistical analysis determines the co-occurrence of the tokens within the topics of interest of the engine. The semantic analysis determines at least one of: the type of each of the one or more tokens, the correlation between each of the tokens and the topic of interest of the engine, and a combination thereof.

The statistical analysis is performed to determine, based on the certainty scores, which entities would best describe the user intent of a request. This may include statistically combining the outputs from engines 146. In another embodiment, the statistical analysis including computing an average over the received certainty scores and considering entities with certainty scores over the computed average. The semantic analysis determines which of the combination of tokens mapped to entities describes a coherent request (or phrase).

The user intent is then sent to the server 130 in order to provide the user with access. It should be noted that each of the units may include a processor coupled to a memory (both are not shown).

As a non-limiting example, the words “manage March Madness bracket” are received as a request by the network interface 242. The request is tokenized by the tokenizer 244 to the tokenized queries “manage”, “March”, “madness”, “bracket” and “March madness.”

The tokenized requests are then sent to a plurality of engines 246. An engine (e.g., engine 246-1) that handles dates will provide a high certainty score (e.g., 10) for the word “March” and the certainty of this word as the 3rd Month of the year, but this engine 246-1 will not provide an output for the tokenized requests “manage”, “madness”, “bracket”, and “March Madness” (or otherwise provide a certainty score below a predefined threshold). An engine (e.g., engine 246-2) that handles a music entity will provide a high certainty score (e.g., 7) for the word “madness” and the certainty of this word as the name of a Music band, but engine 246-2 will not provide an output for the tokenized requests “manage”, “March”, “bracket”, and “March Madness.” An engine (e.g., engine 246-3) that handles basketball will output a high certainty score (e.g., 10) for the tokenized requests “March Madness” and “bracket” and the certainty of this combination of words as a basketball related phrase. Respective thereto the user intent is determined to be NCAA® basketball bracket management, as a coherent request is comprised of entities that best represent the user intent.

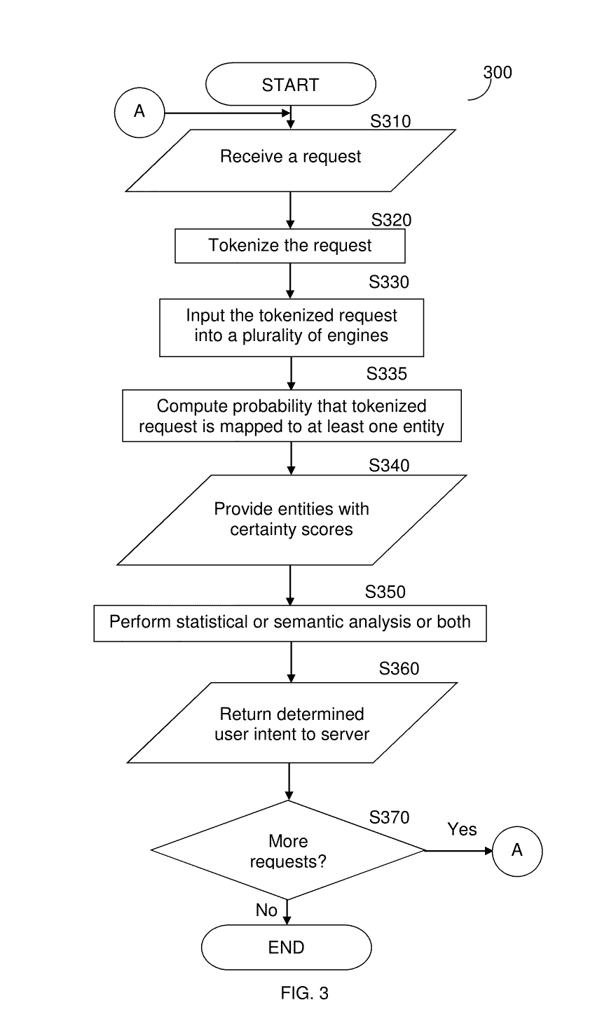

FIG. 3 depicts an exemplary and non-limiting flowchart 300 of a process for detecting a user intent according to one embodiment. In an embodiment, the method is performed by the IDU 140. In S310, the request, or a portion thereof, is received from a user device, for example the user device 110-1.

In S320, the received request is tokenized to one or more tokenized requests. A tokenized request may be any combination of tokens broken from the received request. A token may be a word or phrase that appears in the input query. In an embodiment, S320 is performed by the tokenizer 246. In S330, the tokenized requests are input to the plurality of engines 246-1 through 246-N.

In S335, the probability that a tokenized request is mapped to at least one entity that the engine is configured with is computed by each engine. An entity represents a topic of interest. Various examples of engines and their entities are discussed above. The probability computation is realized by a certainty score. In S340, at least one entity is provided together with a certainty score by each of the engines 246-1 through 246-N. As an example, the tokenized request ‘madonna’ can be mapped to the entities: ‘music player’ and ‘encyclopedia.’ As noted above, in an embodiment, certainty scores below a predefined threshold are not output by the engines.

In S350, at least a statistical analysis, a semantic analysis, or both is performed on at least the certainty scores and entities received from the engines to determine the user intent. In S360, the determined user intent is returned to a server. In an embodiment, the tokenized requests and the user intent are saved in the memory 149. In S370, it is checked whether a new request is received, and if so execution continues with S310; otherwise, execution terminates.

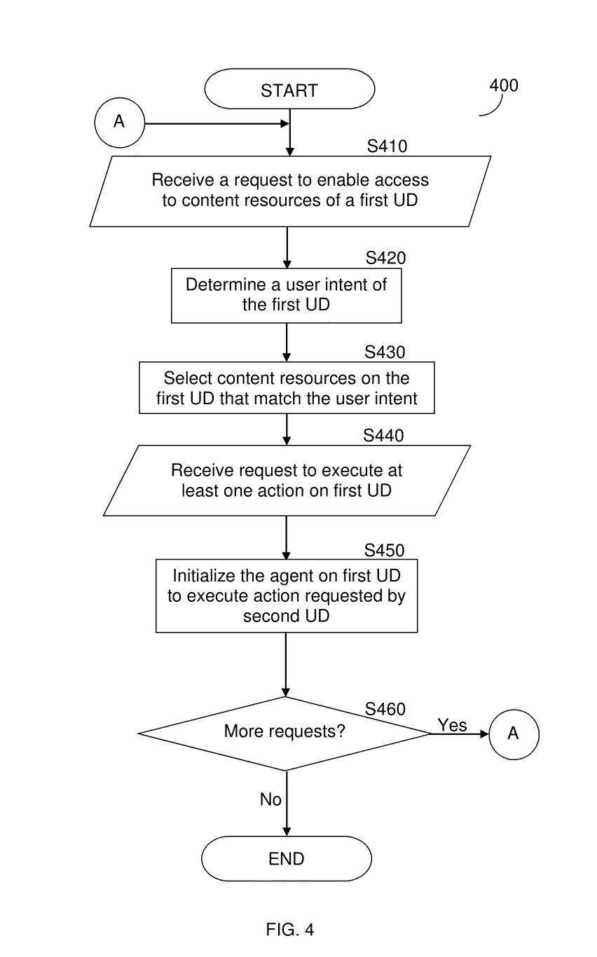

FIG. 4 depicts an exemplary and non-limiting flowchart 400 of a method for enabling cross-devices access respective of a user intent according to one embodiment. The method will be described with a reference to providing access to a user device 110-1 by a user device 110-2. In an embodiment, the method is performed by the server 130.

In S410, a request to enable access to content resources of a first user device, for example, the user device 110-1, is received. The request may be initiated by the first user device 110-1. In an embodiment, the request includes one or more keywords, or portions thereof generally describing the content resources that the second user device 110-2 can access. It should be noted that the keywords may not list the specific details of content resources that should be accessed. For example, the keyword Mexico Summer” may be used for accessing content resources related to “Vacation”.

In S420, the intent of a user of the first user device 110-1 is determined based on the keywords designated in the request. In an embodiment, S420 is performed by the IDU 140 as further described hereinabove with respect to FIGS. 2 and 3.

In S430, based on the determined user intent, content resources on the first user device that match the user intent are selected. In an embodiment, S430 includes selecting from a plurality of content resources of the first user device at least one content resource matching the determined user intent. As for the above example, the user intent for the keywords “Mexico Summer” may be related “Vacation”. The determined content resources in the first user device 110-1 may include applications (apps) for booking flights and a folder of pictures from the user's last vacation.

In S440, a request to execute at least one action with respect to the determined content resources of the first user device 110-1 is received from the second user device 110-2. An action may be, for example, view, open, save, modify or retrieve a file, launch an application, access a folder, and so on.

In S450, an agent (e.g., agent 115) is initialized on the first user device 110-1 to execute the at least one action requested by the second user device 110-2. The agent is executable (or installed) on the first user device. The agent 115 may be part of the operating system of the first user device. Alternatively, the agent may be downloaded from an application program repository, installed, and then initialized on the first user device. It should be noted that upon initialization and execution of the agent on the first user device, the second user device can access the content resources on the first user device. In an embodiment, the agent can be initialized with access control provisions to check if an authorized access is performed by the second user device and to restrict access based on certain permissions.

In S460, it is checked whether further access is requested, and if so execution continues with S410; otherwise, execution terminates.

The various embodiments may be implemented as hardware, firmware, software, or any combination thereof. Moreover, the software is preferably implemented as an application program tangibly embodied on a program storage unit or tangible computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. All or some of the servers maybe combined into one or more integrated servers. Furthermore, a non-transitory computer readable medium is any computer readable medium except for a transitory propagating signal. The display segments and mini-display segments may be shown on a display area that can be a browser or another other appropriate graphical user interface of an internet mobile application, either generic or tailored for the purposes described in detail hereinabove.

All examples and conditional language recited herein are intended for pedagogical purposes to aid the reader in understanding the principles and the concepts contributed by the inventor to furthering the art, and are to be construed as being without limitation to such specifically recited examples and conditions. Moreover, all statements herein reciting principles, aspects, and embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for enabling cross-device access based on a user intent, comprising:
receiving a request to allow a second user device to access a first user device;
determining an intent of a user of the first user device respective of the received request;
determining, based on the user intent, at least one content resource in the first user device that can be accessed by the second user device;
initializing an agent on the first user device; and
causing the agent to enable the second user device to perform at least one action on the at least one content resource.

2. The method of claim 1, further comprising:
receiving a request from the second user device to perform at least one action on the at least one content resource.

3. The method of claim 2, wherein the at least one content resource includes at least any one of: an application, a file, a folder, configuration, and setting of the first user device.

4. The method of claim 3, wherein the at least one action includes any one of: view, open, modify, or retrieve a file, launch an application, and access a folder.

5. The method of claim 1, wherein causing the agent to enable the second user device to perform the at least one action further comprises:
enforcing access control provisions on the at least one action.

6. The method of claim 1, wherein the user intent represents at least a topic of interest to the user of the first user device.

7. The method of claim 6, wherein determining the at least one content resource based on the user intent further comprises:
selecting from a plurality of content resources on the first user device at least one content resource matching the determined user intent.

8. The method of claim 7, wherein determining the user intent further comprises:
tokenizing the request to enable access to at least one token to create at least one tokenized request;
processing the at least one tokenized request by a plurality of engines, wherein each engine of the plurality of engines is configured to compute a certainty score that indicates a probability that the at least one tokenized request is mapped to at least one entity, wherein each engine of the plurality of engines is further configured to correspond to at least one entity indicating a topic of interest, thereby the plurality of engines are configured with different entities;
receiving from a set of engines of the plurality of engines their respective entities and computed certainty scores, wherein the set of engines output computed certainty scores above a predefined threshold; and
analyzing the received certainty scores and the respective entities to determine the user intent.

9. A non-transitory computer readable medium having stored thereon instructions for causing one or more processing units to execute the method according to claim 1.

10. A system for enabling cross-device access based on a user intent, comprising:
a processing unit; and
a memory, the memory containing instructions that, when executed by the processing unit, configure the system to:
receive a request to allow a second user device to access a first user device;
determine an intent of a user of the first user device respective of the received request;
determine, based on the user intent, at least one content resource in the first user device that can be accessed by the second user device;
initialize an agent on the first user device; and
cause the agent to enable the second user device to perform at least one action on the at least one content resource.

11. The system of claim 10, further configured to:
receive a request from the second user device to perform at least one action on the at least one content resource.

12. The system of claim 11, wherein the at least one content resource includes at least any one of: an application, a file, a folder, configuration, and setting of the first user device.

13. The system of claim 12, wherein the at least one action includes any one of: view, open, modify, or retrieve a file, launch an application, and access a folder.

14. The system of claim 10, is further configured to:
enforce access control provisions on the at least one action.

15. The system of claim 10, wherein the user intent represents at least a topic of interest to the user of the first user device.

16. The system of claim 15, is further configured to:
select from a plurality of content resources on the first user device at least one content resource matching the determined user intent.

17. The system of claim 16, wherein when determining the user intent, the system is further configured to:
tokenize the request to enable access to at least one token to create at least one tokenized request;
process the at least one tokenized request by a plurality of engines, wherein each engine of the plurality of engines is configured to compute a certainty score that indicates a probability that the at least one tokenized request is mapped to at least one entity, wherein each engine of the plurality of engines is further configured to correspond to at least one entity indicating a topic of interest, thereby the plurality of engines are configured with different entities;
receive from a set of engines of the plurality of engines their respective entities and computed certainty scores, wherein the set of engines output computed certainty scores above a predefined threshold; and
analyze the received certainty scores and the respective entities to determine the user intent.
